(19) United States
(12) Patent Application Publication
(10) Pub. No.: US 2004/0004827 A1
(43) Pub. Date: Jan. 8, 2004

(54) Light devices using light emitting diodes

(76) Inventor: Christopher William Guest, Brampton (CA)

Correspondence Address: Thomas N. Young, YOUNG & BASILE, Suite 624, 3001 West Big Beaver Road, Troy, MI, 48084-3107, US

(21) Appl. No.: 10/191,961

(22) Filed: Jul. 8, 2002

(51) Int. Cl. F21V 7/04

(52) U.S. Cl. 362/31; 362/249; 362/235; 362/812; 362/800

(57) ABSTRACT

An electrical light device suitable for an illuminated sign or for a lighting fixture comprising a relatively thin plate made of a unitary sheet of transparent or translucent material and having a peripheral edge and flat front and rear surfaces. A plurality of spaced-apart, light emitting diodes (LEDs) are mounted along the peripheral edge and are arranged to transmit light into the plate. A light reflecting, opaque layer covers the rear surface of the plate and a light reflecting, opaque strip is affixed to the peripheral edge and extends along this edge. The opaque strip is arranged to reflect light that has passed through the plate back into the plate. A front sheet or layer, that is at least partially opaque or translucent, extends over the front surface of the plate and provides a lighting effect. Preferably the front sheet is a plastic film attached by repositionable or pressure sensitive adhesive.

### BACKGROUND OF THE INVENTION

This invention relates to light and display devices operated by electrical power and, in particular, to such devices that employ light emitting diodes (LEDs) as the light source.

A wide variety of light fixtures and illuminated sign apparatus are known and are commonly used at present. Most illuminated signs use standard light bulbs of various sorts as a source of illumination or they can take the form of neon signs which use elongate tubes containing neon gas to create a special lighting effect. The signs that employ standard light bulbs can either be illuminated from the front with the light reflecting off the front face of the sign or they can be lighted from the rear with the sign indicia being arranged or displayed on a clear or translucent front plate which can be made of a suitable plastic material, for example. Some disadvantages with known illuminated signs are that they may consume a substantial amount of electrical power over the period of time that they must be lit, the signs can be difficult to change to provide new wording or new designs thereon, and they may not be particularly suitable for many sign applications.

The use of illuminated panels, including signs, that employ light emitting diodes, commonly referred to as LEDs, is also known. For example, U.S. Pat. No. 5,528,709 issued Jun. 18, 1996 describes a panel like light source device wherein light is provided by a few LEDs disposed at the corners of the panel. Diffusion reflective sheets extend along the edge surfaces of the panel and over the rear surface. The rectangular panel acts as a light-scattering light guide and it is made of a material having a uniform light scattering power.

Published U.S. patent application Ser. No. 2001/0049893, which was published on Dec. 13, 2001, describes a luminaire in the form of a thin, light emitting panel having a light emitting window along its front surface. Light sources are arranged along one or two edges of the panel and are in the form of one or more rows of LEDs. A plurality of deformities such as a series of parallel V-shaped grooves are provided on one side of the panel and they are arranged to create at least one light symbol, for example, a letter of the alphabet. Because of the need for the special deformities to be made in the panel, this luminaire may be relatively expensive to manufacture and the indicia produced by the lighted panel generally cannot be changed.

Another recent published U.S. patent application that teaches the use of a planar light emitting device employing LEDs is U.S. application Ser. No. 2002/0051356 published May 2, 2002. This device requires a layered structure composed of a transparent body and a semi-transparent body. The transparent body is made of a transparent synthetic resin containing no light scattering material while the semi-transparent layer is made of a semi-transparent synthetic resin containing a light scattering material. The transparent and semi-transparent layers are joined to form a diffusion layer therebetween, the latter layer having a so-called sea-islands structure. Although this known light emitting device may have a number of applications, it appears that the panel may be relatively expensive because of its unique layered structure and it may not be suitable for all lighting device applications.

It is an object of the present invention to provide an improved, inexpensive light device operated by an electrical panel which can be used for purposes of a sign or advertisement or which can be used to produce other forms of desired lighting effects.

It is a further object of the present invention to provide a novel light device which relies on light emitting diodes as the source of light and which therefore requires a relatively low level of electrical power to operate for extended periods of time.

It is a further object of the present invention to provide a light device which can be manufactured at a relatively low cost using existing materials and well known manufacturing techniques and which can be made light in weight compared to the display area or lighted area of the device.

### SUMMARY OF THE INVENTION

According to one aspect of the invention, a light device operated by electrical power comprises a relatively thin plate capable of illumination comprising a unitary sheet of transparent or translucent material and having a peripheral edge and substantially flat front and rear surfaces. The device also includes a plurality of spaced-apart, electrically connected light emitting diodes (LEDs) mounted on a peripheral edge section of the sheet and extending along at least a substantial section of the peripheral edge and connectable to a source of electrical power, these LEDs being arranged to transmit light into the plate during use of the light device. There are also a light reflecting opaque layer on the rear surface and a light reflecting opaque strip affixed to the peripheral edge and extending along same. The opaque strip is arranged to reflect light that has passed through the plate back into the plate. A cover sheet is detachably mounted on the front surface by means of pressure sensitive adhesive on the cover sheet. The cover sheet is at least partially opaque or translucent and allows light to pass through said front surface to produce a desired lighting effect.

In the particularly preferred embodiment, the plate is about ⅜ inch thick and the cover sheet has indicia formed thereon, for example, indicia creating a sign or advertisement.

Preferably the LEDs are linearly arranged along substantially all of the peripheral edge of the plate and each LED is spaced approximately the same distance from its adjacent LEDs.

According to another aspect of the invention, a display device capable of being illuminated by low levels of electrical power comprises a plate comprising at least one layer of transparent or translucent material, having peripheral edge sections, and having substantially flat front and rear surfaces. The device further includes an opaque plastic frame extending along the edge sections and covering these edge sections and a plurality of spaced, electrically connected light emitting diodes mounted between the plastic frame and the edge sections. The LEDs are connectable to a source of electrical power and arranged to transmit light into the plate during use of the display device. A light reflective layer is provided on the rear surface of the plate and means for forming and displaying indicia are provided on the front surface of the plate. The forming and displaying means are at least partially opaque or translucent and allow light to pass through the front surface of the plate so as to illuminate the indicia.

Preferably the plate consists of only a single layer of transparent or translucent plastic or glass and the peripheral edge sections are formed with a groove extending lengthwise along the edge sections. In this preferred embodiment, the LEDs are located in the groove.

According to a further aspect of the invention, a light device capable of illumination by means of electrical power comprises a transparent or translucent cylindrical, tubular member having a first end, a second end, and cylindrical inner and outer surfaces extending between the first and second ends. A plurality of spaced apart, electrically connected, light emitting diodes are mounted in a peripheral edge section of at least one of the first and second ends and are connectable to a source of electrical power. These LEDs are arranged to transmit light into the cylindrical member from the peripheral edge section during use of the light device. A light reflective, opaque layer covers the inner surface and is arranged between the first and second ends. This opaque layer is arranged to reflect light through the cylindrical outer surface. An outer layer, which is at least partially opaque or translucent, is arranged on the cylindrical outer surface and allows light to escape through at least a portion of the cylindrical outer surface.

In a preferred embodiment of this light device, the LEDs are mounted on peripheral edge sections of each of the first and second ends and are arranged to transmit light into the cylindrical, tubular member from both of the peripheral edge sections during use of the light device.

According to still another aspect of the invention, a light device capable of illumination by means of electrical power includes a plate made primarily of a transparent or translucent layer of material and having four side edges along its perimeter and substantially flat front and rear surfaces. A plurality of spaced apart, electrically connected light emitting diodes are mounted along each of two of said side edges and are connectable to a source of electrical power. These two side edges extend at a substantial angle to each other and the LEDs mounted in one of the side edge sections are arranged to transmit light into the plate which crosses the path of light transmitted into the plate by the LEDs mounted in the other of the side edge sections. There are also means for reflecting light provided on the rear surface and on two of the side edges located opposite the two side edges along which the LEDs are mounted. A front layer extends over and is attached to the front surface of the plate to provide a lighting effect. This front layer is at least partially opaque or translucent.

In one preferred embodiment of this device, the flat rear surface of the plate has been lightly sandblasted prior to a reflecting layer being applied to the rear surface. The effect of the sandblasting is to cause diffusion of light reflected off the rear surface.

According to still another aspect of the invention, a light device capable of being illuminated by means of electrical power comprises a transparent or translucent plate having a plurality of edge surfaces and substantially flat, front and rear surfaces and elongate, opaque, light reflecting frame members mounted on the plate and extending along at least two of the edge surfaces. A plurality of spaced-apart, electrically connected light emitting diodes are mounted in a space between at least one of the frame members and an adjacent edge section of the plate and are held in place by the at least one frame member. These LEDs are connectable to a source of electrical power and are arranged to transmit light into the transparent or translucent plate during use of the light device. There are also provided a light reflective layer on the rear surface of the plate and a front layer capable of providing a desired lighting effect extending over the front surface of the plate. The front layer is at least partially opaque or translucent. During use of the light device, light emitted by the LEDs is transmitted and reflected to the front layer in order to provide the lighting effect at the flat front surface.

Preferably, the front layer is film sheet detachably mounted on the flat front surface, this film sheet forming indicia.

Further features and advantages will become apparent from the following detailed description taken in conjunction with the accompanying drawings.

### BRIEF DESCRIPTION OF THE DRAWINGS

FIG. 1 is a front view of a light device constructed in accordance with the invention but omitting an opaque or translucent indicia forming front layer for sake of illustration;

FIG. 2 is a front view similar to FIG. 1 but showing a fiberglass reflective material on the rear surface visible through the clear panel.

FIG. 3 is a front view of the light device of FIG. 1 with a plastic film forming indicia on its front surface;

FIG. 4 is perspective view showing a rectangular front surface, a top edge surface and a side edge surface of a transparent plate that can be used in the sign of FIG. 1;

FIG. 5 is a perspective view showing a preferred construction of the sign of FIG. 1, this view showing a reflective layer applied to the rear rectangular surface and adhesive tape being applied to edge surfaces of the sign;

FIG. 6 is a perspective view similar to FIG. 4 but showing an alternate form of construction of plate for the light device;

FIG. 7 is a schematic front view of a multi-sided sign constructed in accordance with the invention;

FIG. 8 is a schematic front view of another possible shape of the light device, this shape having a curved edge;

FIG. 9 illustrates an elongate plastic sheet and the manner in which plates usable for the present lighting devices can be cut from such a sheet;

FIG. 10 is a top view of an elongate plastic film from which the indicia forming front layer for a sign can be cut;

FIG. 11 is a side elevation of vehicle fitted with an illuminated sign constructed in accordance with the invention;

FIG. 12 is an edge view of a plastic sheet with arc-shaped grooves formed in opposite edges, the sheet being framed by plastic moldings;

FIG. 13 is a side view of a strip of plastic tape having adhesive strips and an attached string of LED lights;

FIG. 14 is a cross-sectional perspective view of a light device, this view showing the rear surface and a longitudinal edge, the transverse cross-section being taken perpendicular to the front and rear surfaces;

FIG. 15 is a side view of a string of LED lights attached to double sided adhesive tape;

FIG. 16 is a top view of the string of LED lights attached to a reflective adhesive tape;

FIG. 17 is a view of the adhesive side of a strip of reflective tape having locating lines formed thereon;

FIG. 18 is a side view of the tape of FIG. 17 with a string of LED lights attached by adhesive to the tape strip;

FIG. 19 is an edge view of a transparent or translucent plate that can be used in the light device of the invention, this plate being shown with a LED support tape extending along one edge;

FIG. 20 is an edge view similar to FIG. 19 but showing a plastic frame member attached to one edge of the plate;

FIG. 21 is a perspective view of the plastic frame member shown in FIG. 20, this view showing the inside of the channel formed by the frame member;

FIG. 22 is a perspective view similar to FIG. 21 but showing an alternate form of plastic frame member which has fastener holes formed in a connecting flange;

FIG. 23 is a perspective view illustrating an end portion of a plate for a light device of the invention, this plate being formed with an elongate groove in one edge section;

FIG. 24 is a perspective view similar to FIG. 23 but illustrating a strip of LEDs mounted in the groove and covered by a plastic frame member having a U-shaped cross-section;

FIG. 25 is a perspective view of a light device constructed in accordance with the invention, this view being taken from the front and the left side edge, the light device being shown without any indicia forming layer on its front surface;

FIG. 26 is a perspective view similar to FIG. 23 but showing the front surface partially covered by a plastic film having indicia formed thereon;

FIG. 27 is a schematic, perspective view showing portions of a wall and a floor, each incorporating a light device of the invention;

FIG. 28 is a schematic, perspective view showing lighting devices of the invention mounted on a cylindrical pillar;

FIG. 29 is a front view of art work constructed in accordance with the invention and shown in a rectangular frame;

FIG. 30 is a schematic perspective view illustrating how two light devices constructed in accordance with the invention can be used to construct a double sided sign; and

FIG. 31 is a front view of a sign, such as a road sign, incorporating an illuminated sign device of the invention; and

FIG. 32 is a perspective view showing a vertical side of and a top of a cylindrical light device of the invention;

### DETAILED DESCRIPTION OF PREFERRED EMBODIMENTS

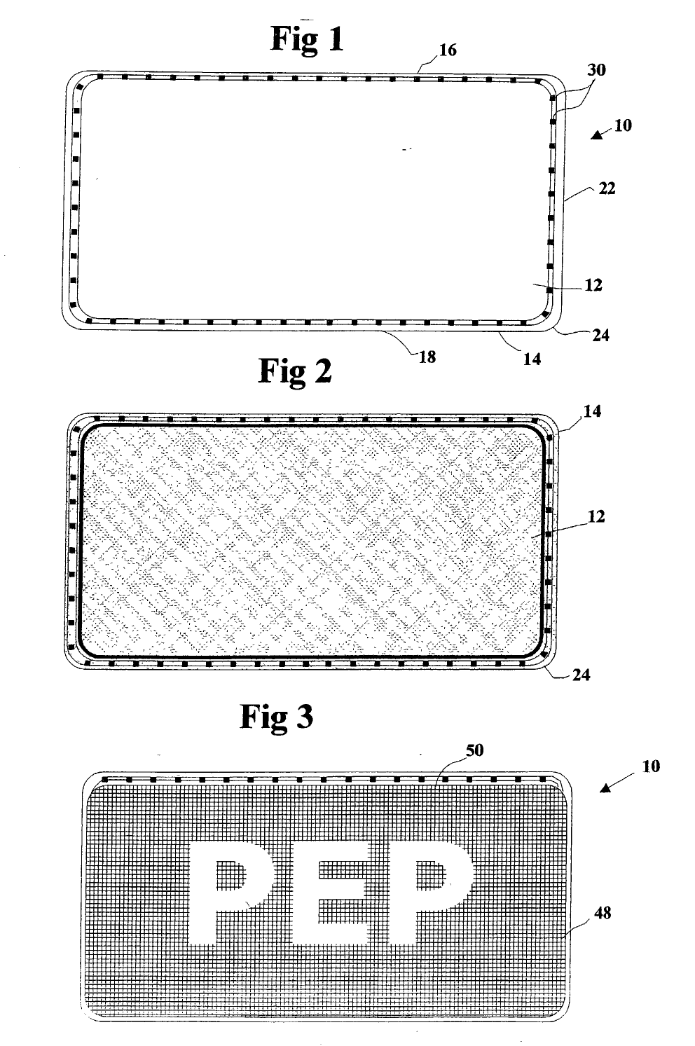

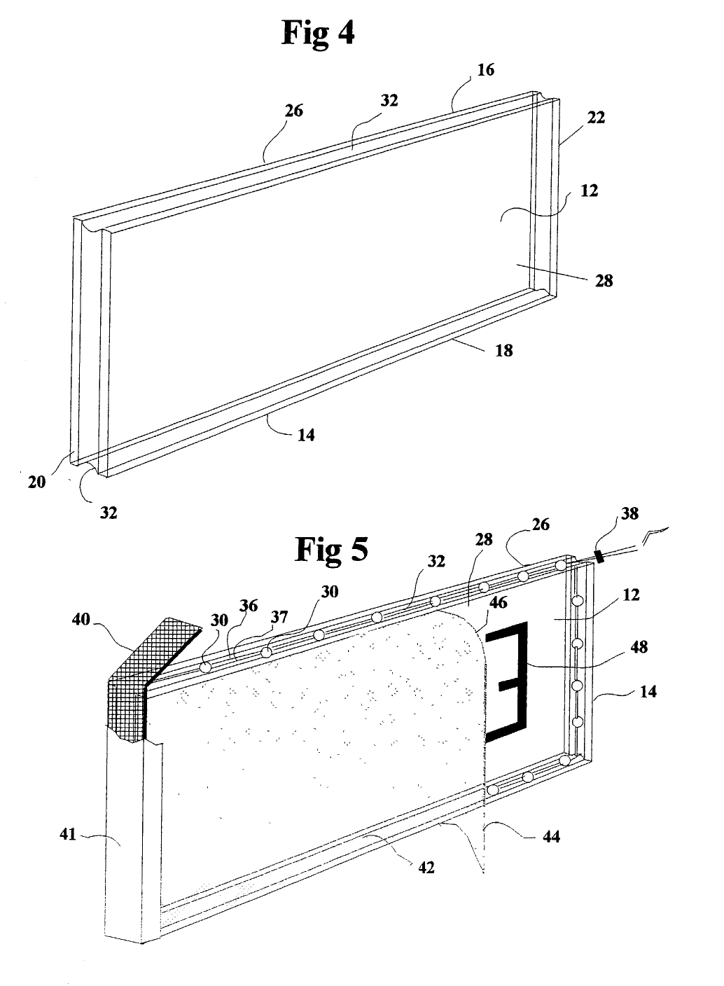

FIGS. 1 to 4 illustrate a preferred embodiment of a light device 10 operated by electrical power and constructed in accordance with the invention. A main component of this light device is a relatively thin plate 12 capable of illumination and comprising a unitary sheet of transparent or translucent material. Suitable materials from which this sheet can be made include relatively rigid, clear or translucent plastics, acrylics, and glass. The sheet has a peripheral edge 14 extending about its perimeter. The sheet can be formed in a variety of shapes as explained further hereinafter, including circular, rectangular and square. As illustrated in FIG. 4, the sheet is rectangular having two longitudinal edges or edge sections 16 and 18 and two side edges or edge sections 20 and 22. In the illustrated preferred embodiment of FIG. 1, these edges meet at four rounded corners 24.

The unitary sheet or plate 12 is illustrated by itself in FIG. 4 and, as can be seen from this figure, the sheet has substantially flat front and rear surfaces indicated at 26 and 28. The expression “substantially flat” as used herein is intended to include not only very flat, smooth surfaces but also surfaces which are slightly rough, pitted or pebbled so that there will be some diffusion of light at the surface. For example, as explained hereinafter, it is possible for some or all of the rear surface to be lightly sandblasted for, purposes of light diffusion and such a surface is intended to be included in the meaning of “substantially flat”. The expression “substantially flat” also includes plates that are somewhat curved in one dimension in order that the light device can be mounted readily on a cylindrical surface, for example, a pillar (see for example FIG. 28). However, the term “substantially flat” does not include plates which are formed with substantial irregularities, for example, light reflecting prisms or elongate, angular grooves that will act to reflect light in a predictable, regular manner. Also, the term “unitary sheet” as used herein to describe the plate 12 shall be considered broad enough to include a sheet or plate made of several layers of the same clear or translucent material provided they are not separated by a layer of a different material, for example, a layer of opaque material, or a layer of a light diffusing material. The term “unitary sheet” shall also include either clear or translucent plexiglass.

Another important component of the light device 10 is that a plurality of spaced-apart, electrically connected light-emitting diodes 30 are mounted on a peripheral edge section of the plate 12, these lights extending along at least a substantial portion of the peripheral edge 14 and connectable to a source of electrical power (not shown). The source of electrical power can be any suitable standard source such as a standard battery having the required voltage and current output or a standard electrical socket or electrical panel providing alternating current at a suitable voltage, for example, 120 volts or 220 volts. In the illustrated embodiment of FIGS. 1 and 2, the light emitting diodes (hereinafter sometimes referred to as LEDs) extend along all four edges 16, 18, 20 and 22 of the plate but it will be understood that the string of LEDs can be provided along only one edge or along only two or three edges, depending upon the desired lighting effect and the amount of light required for the intended use of the light device which, in many cases, will be used as a sign or other indicia displaying device, such as a licence plate. It will be understood that the LEDs are arranged to transmit light into the plate 12 during use of the light device and that light is reflected in the plate in such a manner that it eventually passes out through the front surface of the plate.

Additional preferred features of the light device 10 can be seen from FIGS. 4 to 6 of the drawings. FIG. 4 illustrates the use of a groove 32 extending along the peripheral edge 14 of the plate 12. As illustrated, this groove extends along all four edges 16 to 22 of the plate. However, this groove 32 need only be formed in those edges wherein a plurality of the LEDs 30 are to be mounted. FIG. 5 illustrates schematically how these LEDs 30 are mounted in the groove 32. It will be understood that the light side of each LED faces directly at the bottom of the groove which can be an arc shaped groove as shown in FIG. 4 or a channel shaped groove 34 as illustrated in FIG. 19. The channel shaped groove 34 with its flat bottom is preferred because of its ease of manufacture. The groove can be formed by a simple routing tool of known construction. The LEDs in the string are connected to each other by a plastic tape 40 which can have adhesive on its back side (opposite the LEDs) and which is preferably about ⅜ inches wide. The front side of this tape, that is the side facing the edge of the plate 12, is made highly reflective to reflect light back into the plate.

Other features shown in FIG. 5 include the two electrical lines indicated at 36 and 37 which electrically connect the LEDs in parallel. The lines 36, 37 can be embedded in the plastic tape 40 that connects the LEDs together. These positive (+) and negative (−) electrical lines are connected to a power converter 38 which is of standard construction and which is illustrated only schematically in FIG. 5. It will be understood that the power converter is able to convert the voltage of the power source, for example a battery, to the voltage required for the LEDs, this voltage being typically 0.7 volts. For example, the converter could convert any one or more of the following voltages from the power source to the required voltage to operate the LEDs:

Voltage of Power Source

12

24

110

220

In a preferred light device of the present invention, the power draw of the LEDs is only 4 amps or less. Because of this low power draw, the light device, which typically is a sign or advertisement, can be illuminated for many hours without unduly depleting the power supply and this is particularly advantageous in a situation where the power supply is limited in nature, for example, constructions signs.

Another preferred feature of the present light device shown in FIG. 5 is the use of adhesive tape 41, only a portion of which is shown in FIG. 5. This adhesive tape forms a light reflecting, opaque strip affixed to the narrower plastic tape 40 and to peripheral edge portions of the plate 12 and extending along the peripheral edge of the plate. The preferred adhesive tape 41 is arranged to reflect light that has passed through the plate 12 back into the plate. Preferably, the tape 41 has a light, light-reflecting color, such as white or silver, on its inner surface, that is on the adhesive surface that bonds to the edge surface of the plate 12. This adhesive tape can be of standard construction and can be purchased, for example, from such companies as 3M. Preferably, the adhesive tape 41 extend beyond the edge surfaces of the plate 12 and covers edge portions of the front and rear surfaces of the plate as shown. It will be understood that the width of the edge surface is the thickness of the plate 12 and the edge surfaces extend along all four sides of the rectangular plate shown, that is, the sides 16 to 22. In one preferred embodiment, the width of the tape 41 is about 1 ⅜ inches. It also is noted that the back side of the connecting tape 40 is bonded to the adhesive tape 41 and is thereby held firmly in position.

Also shown in FIG. 5 is a light reflecting, opaque layer 42 provided on the rear surface 28 of the plate and preferably covering the entire area of the rear surface. As illustrated, this opaque layer 42 is partially peeled back at 44 for sake of illustration. One surface of the layer 42, which can be a form of tape, is covered with a suitable adhesive that will adhere to the plastic or glass plate 12. The back or inner surface 46 is pressed against the rear surface of the light device. In order that the opaque layer 42 will be highly reflective, it can be made of a light colored plastic film which is covered with adhesive on one side. Such plastic film is readily available from such companies as 3M and Mactac. One preferred tape or film forming the opaque layer 42 has a highly reflective inner surface and therefore it has a smooth inner surface such as can be formed by plastic film. It is also possible for the opaque layer 42 to have a less than highly reflective inner surface, for example, if diffusion of the reflected light at the rear surface of the panel is desired.

Another preferred feature of the present light device which is illustrated in FIGS. 3 and 5 is a cover sheet 48 that is detachably mounted on the front surface 26 of the plate by means of pressure sensitive adhesive on the cover sheet and that is at least partially opaque or translucent. Thus the sheet 48 is made so as to allow light to pass through the front surface of the plate and produce a desired lighting effect. When the light device is being used as a sign or advertisement, the cover sheet 48 has indicia 50 formed thereon. The indicia can, for example, take the form of lettering forming words (such as the word “PEP” in FIG. 3), numerals, logos, trade-marks, etc. The preferred form of detachable cover sheet 48 is a thin, flexible plastic film with adhesive on one side, for example, the back or inner side that is placed against the plate 12. If the cover sheet is to be readily removable, the adhesive on the film is a repositionable adhesive such as an acrylic pressure sensitive adhesive. Plastic film of this type can be purchased in elongate or rolled sheet form from such companies as 3M and Mactac. It will be understood that when purchased from such companies for use in the present light device, the adhesive is covered with a release sheet which is removed from the adhesive side of the film when the film is to be attached to the front surface of the plate 12.

If the front, indicia forming layer need not be removable from the plate 12 (for example, so that it can be replaced with another cover sheet having different indicia thereon), the front layer of the light device can be formed by other means, for example, by means of opaque or translucent paint applied directly to the plate 12 and applied so as to form indicia, if required. Alternatively, a plastic cover sheet or film can be laminated onto the plate 12 so that it is permanently attached thereto.

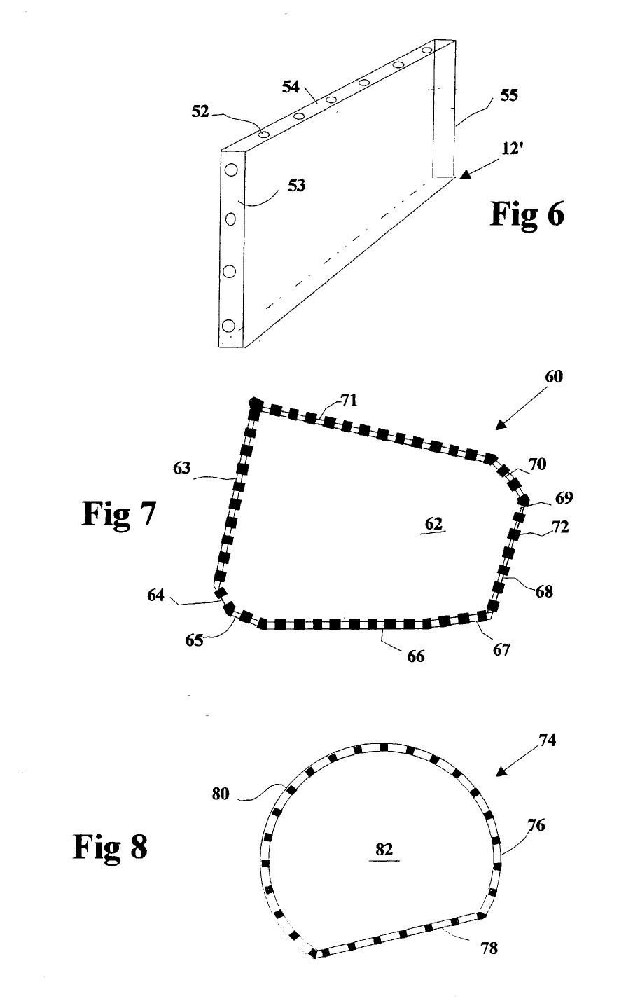

FIG. 6 illustrates an alternate form of plastic or glass plate 12′ in which a number of small, circular holes 52 are formed in the four edge surfaces 53 to 56. These small holes, which can be drilled into the plastic and which can, for example, be ¼ inch deep, replace the elongate grooves 52 shown in FIGS. 4 and 5. The small LEDs are placed individually in these holes 52 and can be held therein by the aforementioned light reflecting tape 41 that extends along the four edge surfaces. As the distance between adjacent LEDs in the strings preferably ranges between ½ inch to 1 inch from center to center, the distance between the centers of the holes 52 also preferably ranges between ½ inch and 1 inch with the most preferred distance being ½ inch. The diameter of these holes is preferably about ⅛th inch for the preferred plate thickness of ⅜ths inch and LEDs of standard construction. It is also possible to place the small LEDs in the holes 52 and to bond or embed them individually in the holes when the plate is manufactured, particularly if the plate is made of plastic or plexiglass.

FIGS. 7 and 8 illustrate that the light device of the invention can be manufactured in a variety of shapes and not simply the rectangular shape illustrated in FIGS. 1 to 6. The light device 60 shown schematically in FIG. 7 is constructed from a thin plastic or glass plate 62 having substantially more than four sides. In fact, as illustrated, the light device has nine sides 63 to 71, these sides varying in length. An LED light string 72 extends about the entire perimeter of the plate 62. Because the present light devices can be made in a wide variety of shapes, these light devices can be used in a wide variety of applications and locations. If large volumes of devices of the same shape are to be made, the manufacturing process can be set up to embed the small LEDs in the plastic plate 62 when it is being made. Such a process will of course permanently attach the LEDs, which has the advantage of a strong attachment but, on the downside, it does not permit the LEDs to be easily replaced, if required.

Turning to FIG. 8, this figure illustrates schematically another light device 74, this light device having a curved peripheral edge at 76 and a straight peripheral edge at 78. A light string 80 extends about the entire periphery of the plate 82, including both the curved and straight edges. Other possible shapes of the light device, that include a curved peripheral edge, are circular and elliptical.

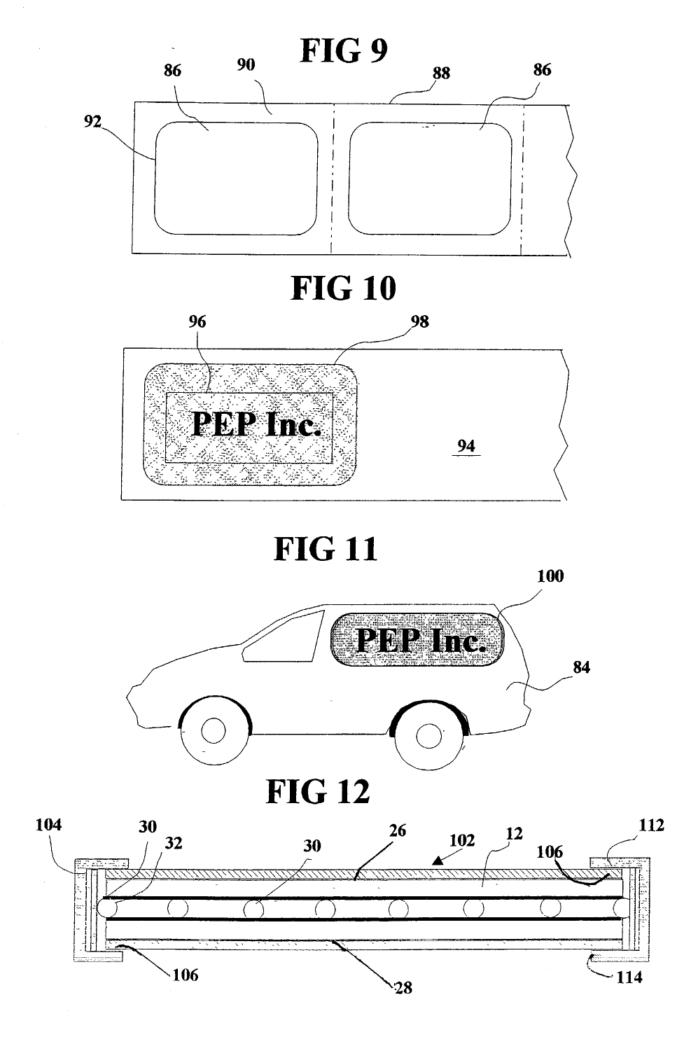

FIGS. 9 to 11 illustrate how a light device in the form of a sign can be manufactured for the side of a van or other vehicle 84. In particular, FIG. 9 illustrates how one or more plastic plates 86 can be cut from an elongate standard sheet of plastic 88. The illustrated plates 86 are substantially rectangular with rounded corners. The preferred thickness of the sheet 88 is ⅜ths inch, a sheet size which is readily available and not too expensive. Generally, a plastic sheet of this thickness is desirable so that the completed light device of the invention will have sufficient rigidity and strength and this thickness also permits the LED string to be mounted along a groove formed in the edge of the plate 86 as already explained. Although it is possible for thicker plastic sheet material to be used for present purposes, for most applications, thicker plastic material is unnecessary and the use of such thicker material will add substantially to the cost of the light device or sign. The plates can be cut from the elongate sheet using a standard plastic cutting tool. The left over material at 90 that is outside the cut line 92 can simply be disposed of or possibly recycled. Once the plate 86 has been cut out from the sheet, the aforementioned groove 32 can be formed along its edge using a routing machine.

FIG. 10 illustrates how the front cover sheet for the van sign can be cut from a standard sheet of plastic film 94 which can be of indefinite length and which may be purchased in the form of a roll. As indicated, this plastic film is preferably provided with acrylic pressure sensitive adhesive on its back side. Again, when the roll of film is purchased, this adhesive is generally covered with a release film or sheet. The indicia or printing for the sign indicated at 96 is preferably formed on the plastic film before the substantially rectangular area 98 for the sign is cut from the film. Again, techniques for forming indicia on films of this type are well known in the printing industry and accordingly a detailed description herein is deemed unnecessary.

FIG. 11 illustrates a light device in the form of a generally rectangular sign 100 attached to the side of the van 84. It will be understood that the sign 100 includes the printed area 98 which has been cut out from the film 94 and a plate 86 of substantially the same size as the film area 98. If the plastic film has been attached by means of a releasable adhesive such as a pressure sensitive adhesive, then this film can be replaced, if desired, in order, for example, to show a different sign. If the sign is intended to be permanent, then the adhesive used to attach the film with the indicia can be a permanent adhesive. Alternatively, in the case of a permanent sign which is not intended to be changed, the opaque or translucent layer on the front surface of the plate can be a layer of paint applied to form the required indicia, decorative patterns, etc.

FIG. 12 illustrates an alternate form of light device or display device 102. This light device includes a transparent or translucent plate 12 similar to that shown in FIG. 4, this plate having an arc-shaped groove 32 extending about its peripheral edge. However, instead of having the tape 41 extending about its peripheral edge in order to hold and mount the string of LEDs, this light device has an opaque, plastic frame 104 extending along peripheral edge sections of the plate and covering these edge sections 106. Of course, instead of plastic, it is also possible to construct this frame of a suitable metal provided of course that the LEDs are electrically insulated from the metal. In the case of a rectangular light device or sign, the plastic frame can extend along all four sides with the four frame members being connected at the four corners by 45 degree mitred joints. The corners can be connected together by a suitable plastics adhesive. The frame 104 preferably comprises a plurality of extruded plastic frame sections (for example four in the case of a rectangular display device) each having a substantially U-shaped transverse cross-sectional shape. Two of these plastic frame sections 108, 110 can be seen clearly in FIG. 14. Each of these frame sections has two parallel spaced-apart leg sections 112 and 114 which extend over edge portions of the front and rear surfaces 26, 28. Preferably the LEDs 30 are connected to one another and are attached to each of the frame sections by one or more reflective adhesive strips indicated at 116 in FIG. 14. These strips extend between the LEDs and the inside surface of the web portion of the frame section. Preferably the adhesive tape holds the LEDs a short distance away from the plate 12 so that the LED lights do not come into contact with the plate if it is made of heat sensitive plastic. If the plate 12 is made of heat resistant plastic, then the LEDs can be placed tight against the edge surface of the plate.

With reference now to FIGS. 15 and 16, FIG. 15 simply shows a portion of a string of LED lights 30 attached to a light reflecting adhesive tape 116 before this tape is attached to the frame member. As shown in this figure, the layer of adhesive 117 is covered with release paper 118 of well known construction per se. The release paper is shown partially peeled back at the left hand end. Also visible in FIG. 15 is one of the electrical lines 36 that connects the LEDs in the string. The top view shown in FIG. 16 shows both of these electrical lines 36, 37 extending one beside the other between the row of LED lights. It will be understood that the top or front surface indicated at 120 is preferably highly reflective so that any light from the LEDs striking this surface is almost totally reflected back into the plate. For this reason, the tape is preferably plastic tape having a very smooth, reflective top surface. Instead of the illustrated tape, it is possible to substitute a mirror strip or a highly reflective foil strip, either of which can be bonded by pressure sensitive adhesive to the inside surface of the plastic frame. The adhesive on the back side of the tape should be releaseable or pressure sensitive in order to allow the string of LED lights to be removed from the plastic frame for maintenance, repair or replacement. Another preferred form of tape 116 is fiberglass tape with a smooth, reflective surface.

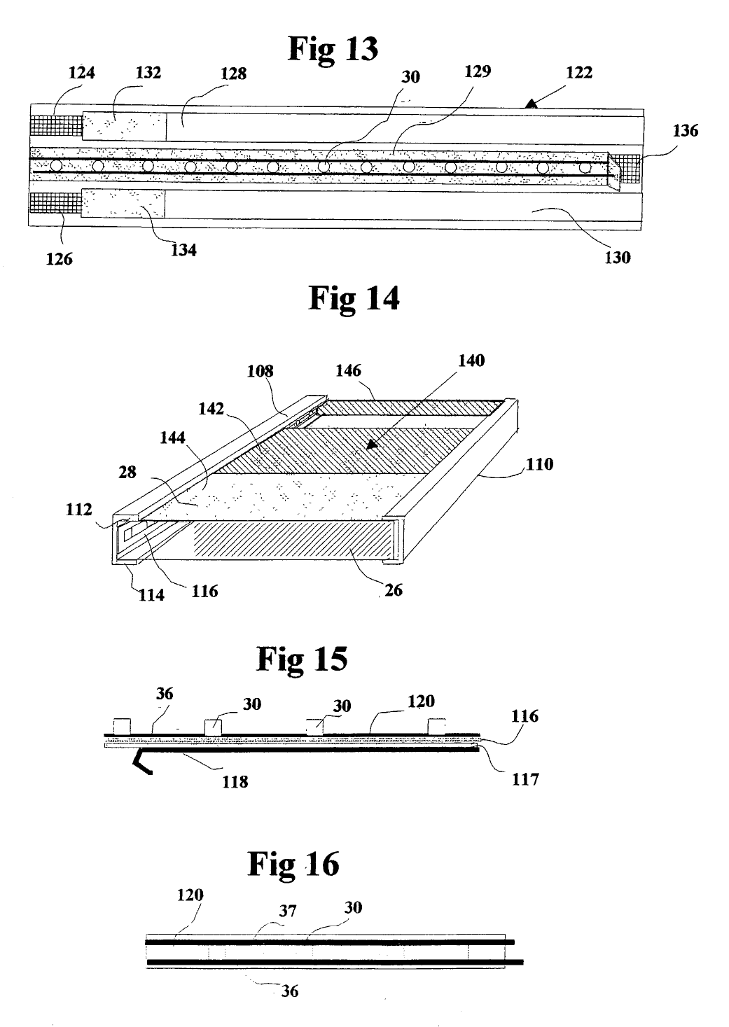

Turning now to FIG. 13, this figure also shows the use of a flexible plastic tape coated with adhesive strips. The front surface of this tape 122 has two, parallel, spaced-apart adhesive strips at 124 and 126. These strips are initially covered by strips of release-paper 128, 130. The left hand end portion of this release paper is shown as partially peeled back at 132, 134. Mounted down the center of the plastic tape is a string of LEDs 30 which are mounted on their own support tape or strip 129. The tape with the LEDs is bonded to the plastic tape 122 by a central strip of adhesive indicated at 136. Again, this central strip of adhesive can initially be covered by a strip of release paper, if desired. Thus, it will be appreciated that in this version, the plastic tape that is used in fact has three distinct parallel adhesive strips 124, 126 and 136. Once the initial placement of the LEDs in the groove 32 has taken place, then one of the release papers 128, 130 can be removed and the respective adhesive strip 124, 126 used to attach one side edge portion of the plastic tape to either the front or rear surface of the plate 12. Then the other release paper 128, 130 is removed to expose the remaining adhesive strip and then the respective exposed adhesive strip is used to attach the remaining side section of the plastic tape to the remaining front or rear surface of the plate. The entire adhesive covered surface of the plastic tape 122 is preferably highly reflective so that most of the light from the LEDs is reflected into the plate 12.

Returning again to the cross-sectional view of FIG. 14, the upper surface of the light device shown in this view is in fact the rear surface of the light device or sign. This rear surface 140 is shown as partially covered by a light reflective layer 142 which may be in the form of opaque plastic film coated with adhesive on its front side, that is the side facing the rear surface 28. It will be understood that in the case of most light devices and signs constructed in accordance with this invention, the reflective layer 142 covers all of the rear surface. Shown next to the reflective layer 142 is an area 144 which has been lightly sandblasted in order to provide a light reflecting surface which also acts as a light diffuser. This sandblasting is carried out when the plastic or glass plate 12 is manufactured, in most cases, and generally the entire rear surface 28 is sandblasted and then it is covered with the reflective layer 142. Also shown in FIG. 14 is a strip of reflective material or tape at 146 which can be the same material as the adhesive tape 116. Although not clearly shown in FIG. 14, it will be understood that the reflective material 146 is enclosed by and affixed to a plastic frame member similar to frame sections 108, 110. It is also possible to construct the light device of the invention with no rear reflective layer 142 but only a light diffusing rear surface, that is, for example, with the rear surface lightly sandblasted or otherwise manufactured to diffuse and reflect light at this surface. In such a light device, some light will pass out of the plate through the rear surface and this may be desirable for some applications.

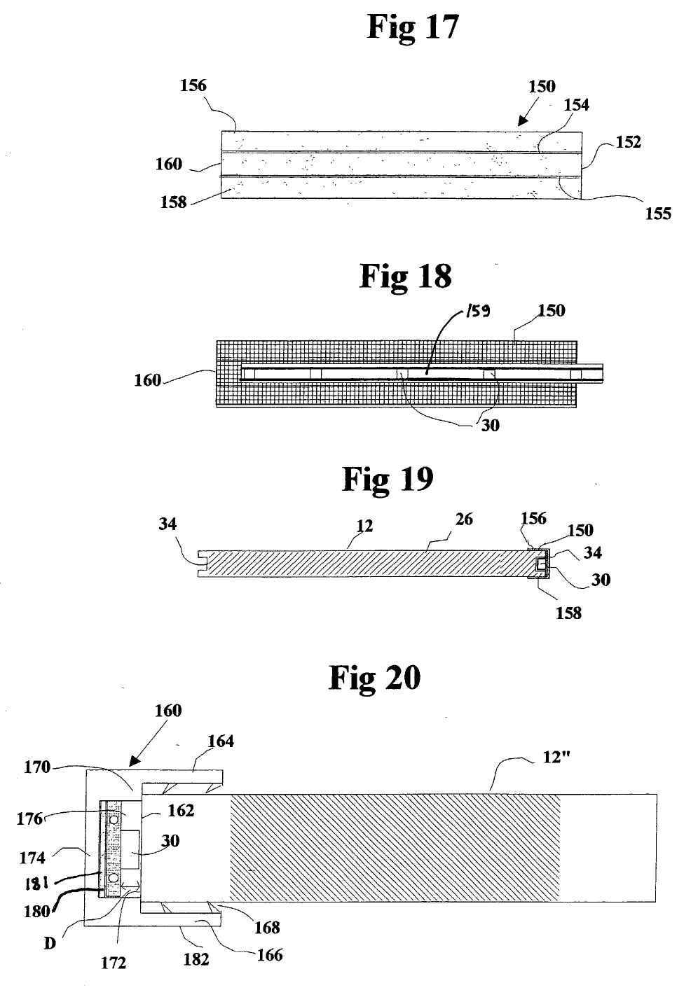

Turning to FIG. 17 of the drawings, this figure illustrates one form of reflective tape 150 that can be used to construct a light device of the invention. This reflective tape has adhesive covering its front or inner side 152. Extending the length of the tape are two marker or locating lines 154, 155. Using these lines, it is easy to correctly place and locate the string of LEDs on the tape before the tape is applied to the edge of the plate 12. Also, the marker lines can assist in correct placement of the tape on the edge surface of the plate so that an equal longitudinal portion of the tape projects from both edges of the edge surface of the plate. It will be understood that the longitudinal section 156 of the tape is secured against either the top or bottom surface of the plate when the LEDs are in their correct position while the opposite longitudinal edge section 158 is pressed against the opposite front or rear surface of the plate.

Turning to FIG. 18, this figure also shows a length of tape 150 but attached centrally on this tape is a tape 159 of LEDs 30 attached by electrical wires. It will be understood that the support tape 159 is secured by adhesive to the central section 160 of the reflective tape.

As indicated previously, FIG. 19 shows a clear or translucent, plastic or glass plate 12 having channel-shaped grooves 34 to accommodate the LEDs. On the right hand edge of the plate there is shown a strip of reflective tape 150 which can be similar to the tape illustrated in FIGS. 17 and 18. Longitudinal edges sections 156, 158 are shown attached to a front surface 26 and a rear surface 28 of the plate. FIG. 19 also illustrates an LED arranged centrally in the channel-shaped groove and held therein by the tape 150.

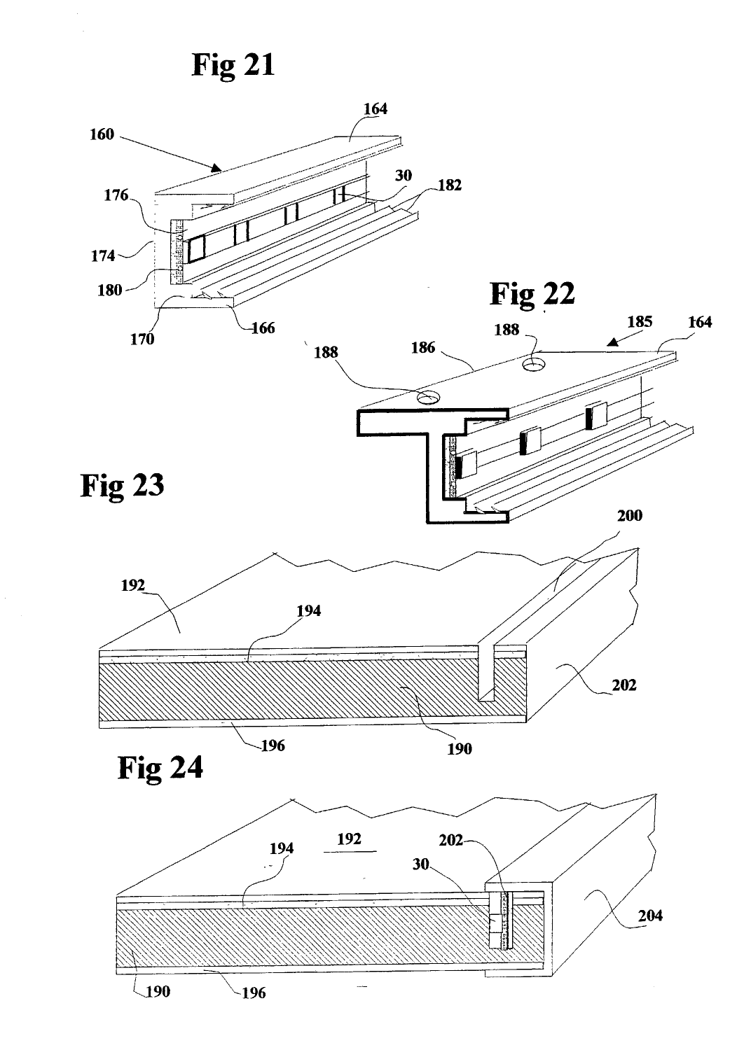

Turning to FIGS. 20 and 21, these figures illustrate an alternate form of opaque, plastic frame member 160 that can be used to mount a string of LEDs 30 to the plastic or glass plate 12″. With the use of this type of frame member, there is no need for grooves to be formed in the plate and the plate 12″ as shown has a flat, unbroken edge surface at 162. If the plate 12″ is rectangular, it will be understood that the frame members 160 can extend along all four edges of the plate. Each frame member 160 again has a substantially U-shaped transverse cross-sectional shape as seen in FIG. 20 and has two parallel, spaced apart leg sections 164, 166 which extend over edge portions 168 of the front and rear surfaces of the plate 12″. Each leg section 164, 166 is formed with an internal shoulder 170 having a top or outwardly facing surface 172 that is spaced by a distance D from a web section 174 of the frame section. The web section 174 interconnects in an integral manner the two leg sections 164, 166. The adjacent peripheral edge section of the plate 12″ rests against and is engaged by the internal shoulders 170 of the frame section. A string of LEDs 30 is mounted in each frame section 160 and is mounted in a space 176 formed between the shoulders 170 and between the web section 174 and the respective adjacent edge section of the plate 12″.

Also shown in FIGS. 20 and 21 is an adhesive support tape or strip 180 that is used to connect the LEDs and attach the string of LEDs to the inner surface of the web 174. The adhesive strip 180 has an adhesive layer 181 on its back side. Thus, the adhesive layer 181 of the strip 180 bonds the strip to the inner surface of the web.

An optional preferred feature of the frame section 160 is the use of one or more elongate, flexible gripping projections or ridges 182, each of which can extend the length of the frame member. In the illustrated embodiment, there are four of these projections or ridges with two being on each of the leg sections. These projections slope inwardly to a relatively sharp, elongate edge that engages either the rear surface or the front surface of the plate 12″. Thus, these gripping projections securely engage the adjacent surfaces of the plate so that the edge section of the plate is firmly held in the plastic frame member.

FIG. 22 shows another form of plastic frame member 185 that is similar in its construction to the frame member 160 except for the differences now noted. Again, the frame members 185 can be used to construct a light or display device in accordance with the invention and each frame member 185 extends along one of the straight edge surfaces of the plate 12″. It is also possible to combine frame members 160 with frame members 185, if desired. Each frame member 185 includes an integral connecting flange 186 that projects outwardly and away from the plate 12″ and also in a direction opposite to leg section 164. The connecting flange is preferably formed with holes 188 for mounting the light or display device by means of standard fasteners (not shown). For example, suitable screws or bolts can extend through the holes 188 and are attached to a suitable adjacent support structure.

FIG. 23 illustrates an alternative form of plate construction that can be used to make a light device or a display device in accordance with this invention. As shown, in this embodiment there is a transparent or translucent, plastic or glass plate 190 and the peripheral edge surfaces of this plate can be flat, that is, without any longitudinal groove extending along the edge surface. Located on the rear surface of this plate is a reflective, opaque layer 192 which can be in the form of opaque, plastic film attached to the plate 190 by means of an adhesive layer 194. Also shown in FIGS. 23 and 24 is an opaque or translucent front layer 196 which can comprise paint applied to form and display indicia on the front surface of the plate.

The unique feature of the embodiment of FIGS. 23 and 24 is that there is an elongate groove 200 formed in either the front surface or the rear surface of the plate 190. As illustrated, this groove 200 is formed in the rear surface of the plate, a short distance from peripheral edge surface 202. The groove 200 can extend the entire length and/or width of the plate 190 and it can extend through the reflective layer 192 as shown, if desired. With this embodiment, it is possible to still mount a string of LED lights 30 but it may be necessary for the plate 190 to be thicker if it is to accommodate a standard string of LEDs. In the above described embodiments wherein the groove 32 or 34 is formed in the edge surface itself, the plate 12 must have sufficient thickness to accommodate a groove that is large enough in its transverse dimensions to accommodate the standard string of LED lights. In practical terms, this means that in order for the groove to extend along the side edge surfaces, the thickness of the plate 12 should be about ⅜ inch. In FIG. 24, the LED lights are shown as secured in the groove 200 by means of their connecting strip of plastic reflective tape 202 that extends along an outer side of the groove 200, so that the LEDs face inwardly towards the center of the plate. Attached to the edge section of the plate is an opaque, light reflecting plastic frame section 204 which can be attached to the edge section by means of a friction fit or adhesive. The frame section preferably extends over the top of the groove 200 as shown. Again, the frame section 204 has a U-shaped cross-section. Of course, as an alternative, instead of the frame section 204, one can employ a strip of reflecting adhesive tape that extends along both the adjacent edge surface of the plate and over edge sections of the front and rear surfaces of the plate.

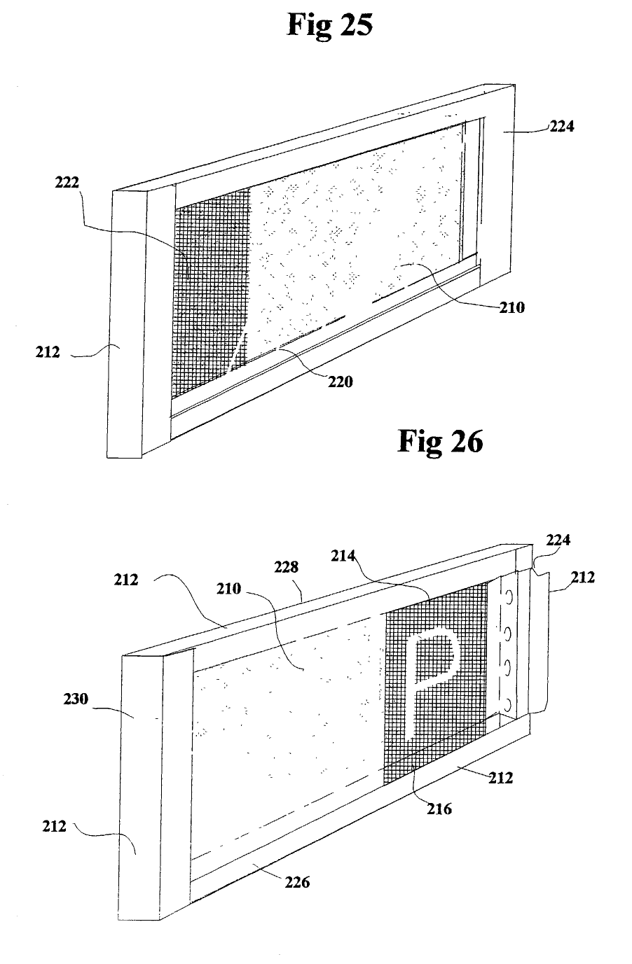

FIGS. 25 and 26 illustrate another version of a display device constructed in accordance with the invention, the illustrated version employing a rectangular, clear plastic plate 210. Extending along each of the four edge surfaces of the plate is reflective adhesive tape 212 that is preferably plastic tape having a smooth, highly reflective inner surface. As shown, the tape 212 extends over edge sections of the front and rear surfaces of the plate 210. Mounted on the front surface of the plate is a plastic film 214 with indicia (in this case the letter “P” formed thereon). The indicia can be formed by the shape of clear or transparent areas on the film. This plastic film has opaque regions 216 through which the light from the LEDs cannot pass. As already indicated, it is also possible for this plastic film to have translucent regions which permit some light to pass and which may provide a color effect, for example.

With specific reference to FIG. 25 wherein the clear front surface of the plate can be seen, the rear surface of this plate is preferably covered with a layer of reflective material indicated at 220 that generally covers the entire rear surface. Also, shown in FIG. 25 is a rectangular area 222 which has been lightly sandblasted in order to cause the reflected light to be diffuse. Although the indicated area 222 is only a portion of the rear surface, it will be understood that this is for illustration purposes only and that normally the sandblasting would cover the entire rear surface of the plate. As explained earlier, the sandblasted surface is preferably covered with a layer of opaque, reflective material such as white tape or while plastic film. The use of a sandblasted rear surface is a preferred feature as it will diffuse the light that reflects off the rear surface and this in turn can enhance the lighting effect at the front surface of this display device. Instead of using the adhesive tape 212, as explained above, elongate plastic frame members can be mounted on each of the straight edges of the plate. These frame members, which have a highly reflective inner surface are preferably made of plastic but it is also possible to use metal extrusions and the use of such metal extrusions will assist in preventing any heat build up from the operation of the LEDs.

In the illustrated light device of FIGS. 25 and 26, a plurality of light devices 30 are mounted along at least two edges of the plate 210 or they can be mounted along all four edges. There can be, for example, a plurality of LEDs mounted along the right side edge at 224 as well as a plurality of LEDs mounted along the long, bottom edge 226. The side edges 224 and 226 extend at a substantial angle to each other with the illustrated angle being 90 degrees. It will be seen that the LEDs mounted along one of these side edges, for example, the right side edge 224, are arranged to transmit light into the plate 210 which crosses the path of light transmitted into the plate by the LEDs mounted along the other of the side edges, that is, the bottom edge 226. Moreover, these criss-crossing light beams are reflected back by the reflective tape that is provided on two of the side edges at 228 and 230 that are located opposite the two side edges 212, 226 along which the LEDs are mounted. Note that this reflecting capability applies also in the case where LEDs are mounted along all four side edges. This criss-crossing and reflection of the light beams can result in a very uniform illumination of the plate which in turn creates a uniform illumination of the indicia forming layer or film on the front surface of the plate.

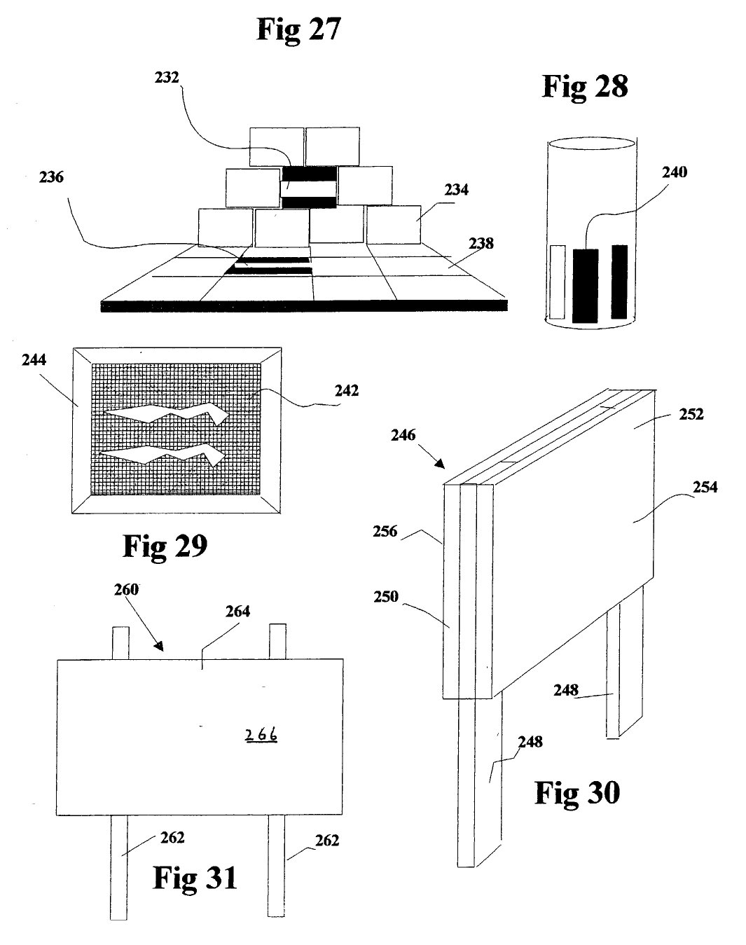

FIG. 27 illustrates how a light device constructed in accordance with the invention can be mounted on a wall or built into a tile floor. The wall could be constructed from bricks, blocks, and suitably shaped stone. The light device at 232 is rectangular in shape and is mounted on the wall 234. The light device 232 can be constructed substantially in the same manner as the light device illustrated in FIG. 3. It is attached to the brick or block surface by means of any suitable attachment means, for example, known fasteners or anchors for attaching objects or devices to a solid brick or block wall. The light device may have no indicia on its front surface but instead, for example, may have a translucent, colored plastic sheet on its front surface to create a certain lighting effect. The rectangular lighting device 236 is shown as replacing one of the tiles 238 that form a floor surface. Thus, the light device 236 can be made the same size as one of the tiles. The light device 236 can be made quite durable and long lasting if it is made of a suitable, high strength material such as acrylic. Again, the light device 236 may or may not be made with an indicia forming layer on its front surface. If it has no indicia on its top layer, the top layer may simply provide a desirable lighting effect, for example, an illuminated pattern or a particular, attractive color.

Turning to FIG. 28, this figure illustrates how one or more light devices 240 can be mounted to the side of a suitable support pillar, for example, a concrete pillar in a building. The light device 240 can be attached by suitable, known types of fasteners, for example, existing fasteners or anchors used to attach objects to concrete. For this purpose, suitable fastener holes can be formed in the light device about its perimeter. In order to match the curved exterior of the concrete pillar, the light device of the invention can be made with a corresponding curve extending in one direction. Light devices that are curved in this manner shall still, for purposes of the present application, be considered to be made of a plate in the form of a unitary sheet of transparent or translucent material. It is also possible to use light devices constructed in accordance with the invention along walls or walkways made from other building materials. For example, it is possible to attach such light devices along the wall of a concrete tunnel, if desired.

FIG. 29 simply illustrates how a light device or display device constructed in accordance with the invention can be used to make an illuminated work of art. As shown, the work of art 242 is mounted in a standard picture frame 244 that extends about the entire perimeter of the work of art. The work of art 242 can be made in essentially the same manner as, for example, the light device illustrated by FIGS. 1 to 3. However, instead of indicia in the form of lettering being formed on the front cover sheet, a decorative pattern, illustration or picture is formed on the front sheet.

FIG. 30 illustrates how display devices constructed in accordance with the invention can be used to construct a double sided sign 246. This sign can include vertically extending support posts 248 that can be attached at the bottom to a support surface or mounted in the ground. Rigidly mounted on opposite sides of the posts are two display devices 250, 252, for example, display devices constructed in accordance with the above described embodiment of FIG. 3. The required illuminated indicia can be provided on both the vertical surface 254 and the opposite vertical surface at 256.

FIG. 31 simply illustrates how a display device of the invention can be used to construct a sign such as a billboard sign, a road sign or a directional sign. This sign 260 includes two upright support posts 262 and a rectangular display device 264 which can have indicia (not shown) on its front surface 266. It will be appreciated that it is easy to attach the display device 264 to the posts 262 by known means, for example, by the use of standard fasteners extending through holes formed in the light device. Other types of illuminated signs are also possible. For example, it is possible to construct a multi-sided sign in the shape of a block. The sides of a block can be constructed using a plurality of the light devices of the invention secured to one another at their edges or to an underlying support block.

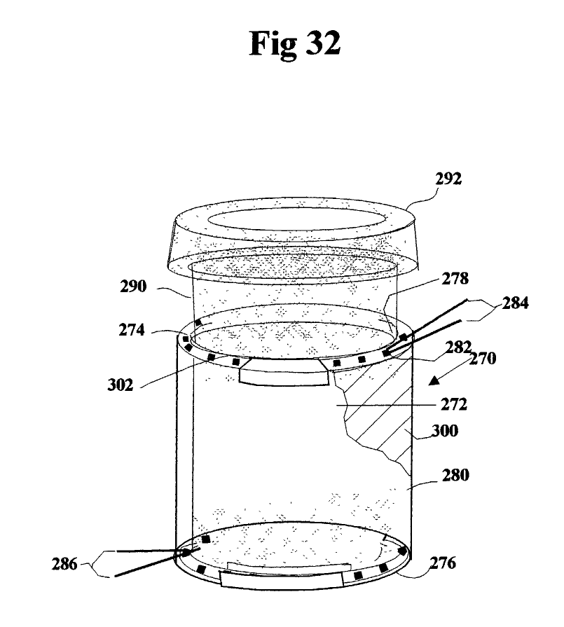

Yet another embodiment of the invention is illustrated in FIG. 32. This light device is indicated generally at 270 and it includes a transparent or translucent, cylindrical, tubular member 272 consisting substantially of translucent or transparent material, ie. a suitable plastic or glass. The tubular member has a first end 274 and a second end 276 and cylindrical inner and outer surfaces 278, 280 extending between the first and second ends. A plurality of spaced apart, electrically connected, light emitting diodes (LEDs) 282 are mounted in a peripheral edge section of at least one of the first and second ends and are connectable to a source of electrical power by means of electrical wires indicated at 284 and 286. In the illustrated embodiment there are a plurality of LEDs mounted at both the first and the second ends of the tubular member. It will be understood that the LEDs are arranged to transmit light into the cylindrical member from the peripheral edges sections during use of the light device.

The light device 270 further includes a light reflective opaque layer covering the cylindrical inner surface 278 which can be lightly sandblasted (if desired for enhanced light diffusion). In the illustrated preferred embodiment, this reflective opaque layer is provided by a cylindrical tube 290 of reflective material arranged inside the tubular member 272 and preferably covering substantially all of the cylindrical inner surface. For sake of illustration only, this cylindrical tube is shown as projecting from the top of the tubular member 272 but, when fully installed, the cylindrical tube 290 does normally not project significantly from the end of the tubular member 272. If desired, an annular end flange 292 can be provided on one end of the cylindrical tube 290 and this end flange can help to properly locate the tube 290 in the tubular member 272 and to hold the tube 290 in its proper position. It is also possible to provide an end flange 292 at each end of the tube 290, if desired. The second end flange can be formed after the tube has been inserted into the tubular member 272. It will be understood that the opaque layer formed by the tube 290 is arranged to reflect light from the LEDs through the cylindrical outer surface 280.

The light device 270 further includes an outer layer 300, only a portion of which is shown in FIG. 32 for ease of illustration. This outer layer on which indicia can be formed allows light to escape through at least a portion of the cylindrical outer surface. The outer layer 300 is at least partially opaque or translucent. In a preferred embodiment, the outer layer is a plastic film which can be similar in its construction to the plastic films used on the planar light devices described above. The plastic film preferably has a layer of pressure sensitive adhesive on one side that is used to bond the plastic film to the cylindrical outer surface 280. In this way, the indicia or display on the outer surface can be changed readily, when required.

In one preferred embodiment of the light device 270, the tubular member 272 is made of clear plastic and the LEDs 282 are substantially evenly distributed about the circumference of each of the first and second ends and are mounted in a circumferential groove 302 formed in each of the peripheral edge sections of the tubular member. It will be understood that the LEDs can be held in place in the same manner that they are mounted and held in place in the planar light devices described above. In particular, the LEDs 282 can be held in place in the aforementioned circumferential groove by means of reflective adhesive tape (only a portion of which is illustrated) that extends substantially about the circumference of each of the peripheral edge sections. Again, this adhesive tape preferably extends a short distance along both the inner surface 278 and the outer surface 280 at each end of the tubular member in order to reflect light into the tubular member in the region of the LEDs.

With respect to the LEDs used in the light devices of the invention, most LEDs are made from gallium arsenide or other semi-conductor compounds that give up energy in the form of light. As is well know, as current flows through an LED, free electrons and holes near the p-n junction combine and when a free electron “falls” into a hole, the process releases a tiny packet of light energy called a photon. With a strong enough current, the junction area of the chip glows brightly. Known LEDs give off red, yellow or green light when electric energy excites their atoms. As a light source, LEDs have the clear advantages of using little power and the ability of lasting almost indefinitely. Also, LEDs operate at relatively low voltages between about one and four volts and draw currents between about ten and forty milliamperes.

In addition to standard plastics and glass, it is also possible to construct a light device of the invention using Plexiglas for the thin plate that forms the main component of the device. The use of Plexiglas can be advantageous in some applications, particularly where safety becomes a concern if the device becomes damaged.

It will be appreciated that light or display devices constructed in accordance with the invention can have a wide variety of applications because of the unique characteristics of these devices. For example, they can be used not only for panel advertising and illuminated signs, but also for smaller illuminated items such as licence plates, store labels and instrument lights. Because of the low power consumption and low voltage requirements of the present light devices, they can be powered by a variety of light sources, including solar cell power and batteries that can be recharged by means of solar cells. The ability of such display devices to be powered by such means as batteries permits them to be used in remote locations where regular, line power is not available.

As will be readily apparent to those skilled in the construction of illuminated signs and displays, various modifications and changes can be made to the described and illustrated light and display devices without departing from the spirit and scope of this invention. Accordingly, all such modifications and changes as fall within the scope of the appended claims are intended to be part of this invention.

I claim:

1. A light device operated by electrical power comprising:
a relatively thin plate capable of illumination comprising a unitary sheet of transparent or translucent material and having a peripheral edge and substantially flat front and rear surfaces;
a plurality of spaced-apart, electrically connected light-emitting diodes (LEDs) mounted on a peripheral edge section of said sheet and extending along at least a substantial portion of said peripheral edge and connectable to a source of electrical power, said LEDs being arranged to transmit light into said plate during use of the light device,
a light reflecting, opaque layer on said rear surface,
a light reflecting, opaque strip affixed to said plate at said peripheral edge, extending along said peripheral edge, and arranged to reflect light that has passed through said plate back into said plate; and
a cover sheet detachably mounted on said front surface by means of pressure sensitive adhesive on said cover sheet, said cover sheet being at least partially opaque or translucent and allowing light to pass through said front surface and produce a desired lighting effect.

2. A light device according to claim 1 wherein said plate is about ⅜ inch thick and said cover sheet has indicia formed thereon.

3. A light device according to claim 1 wherein said LEDs are linearly arranged along substantially all of said peripheral edge of said plate and each LED is spaced approximately the same distance from its adjacent LEDs.

4. A light device according to claim 1 wherein said plate is formed with a groove extending along said peripheral edge section and said LEDs are mounted in said groove by means of said opaque strip attached at said peripheral edge section.

5. A light device according to claim 1 wherein said rear surface of said plate has been sandblasted to provide a rough surface that diffuses light reflected off said rear surface.

6. A light device according to claim 5 wherein said LEDs are bonded to the peripheral edge section of said sheet which is made of plastic material.

7. A light device according to claim 4 wherein said groove is formed centrally in edge surfaces extending along said peripheral edge and between said front and rear surfaces and said groove has a maximum depth of about ¼ inch.

8. A light device according to claim 4 wherein said opaque strip includes adhesive tape having a width greater than the thickness of said plate so that the adhesive tape covers the entire width of an edge surface extending along said peripheral edge and edge portions of said front and rear surfaces.

9. A light device according to claim 8 wherein said adhesive tape is plastic tape having a white or silver color.

10. A light device according to claim 5 wherein said opaque layer on said rear surface is a reflecting film having an adhesive coating on one surface thereof and said film is bonded by said adhesive coating to said rear surface.

11. A light device according to claim 4 wherein said opaque strip includes one or more plastic extrusions, that are substantially channel-shaped in cross-section, and each plastic extrusion has two parallel, elongate legs that engage edge portions of said front and rear surfaces of said plate.

12. A light device according to claim 11 wherein each leg of each plastic extrusion is formed with an internal shoulder, the two shoulders of each plastic extrusion form an elongate cavity between them for receiving a string of said LEDs, and a portion of said peripheral edge of said plate engages said two shoulders so that the plate does not extend into said cavity.

13. A display device capable of being illuminated by low levels of electrical power, said display device comprising:
a plate comprising at least one layer of transparent or translucent material, having peripheral edge sections, and having substantially flat front and rear surfaces;
an opaque frame extending along said edge sections and covering said edge sections;
a plurality of spaced, electrically connected light emitting diodes (LEDs) mounted between said frame and said edge sections and connectable to a source of said electrical power, said LEDs being arranged to transmit light into said plate during use of said display device;
a light reflective layer on said rear surface of said plate; and
means for forming and displaying indicia on said front surface of said plate, said means being at least partially opaque or translucent and allowing light to pass through said front surface of the plate so as to illuminate the indicia.

14. A display device according to claim 13 wherein said plate consists of only a single layer of transparent or translucent plastic or glass, said peripheral edge sections are formed with a groove extending lengthwise along the edge sections, and said LEDs are located in said groove.

15. A display device according to claim 13 wherein said frame comprises a plurality of extruded plastic frame sections each having a substantially U-shaped transverse cross-sectional shape and two parallel, spaced-apart leg sections which extend over edge portions of said front and rear surfaces.

16. A display device according to claim 15 wherein said LEDs are attached to said frame sections by one or more reflective adhesive strips which extend between said LEDs and said frame sections.

17. A display device according to claim 14 wherein said rear surface of said plate has been sandblasted so that said rear surface is rough and diffuses light reflected by said reflective layer.

18. A display device according to claim 15 wherein each leg section is formed with an internal shoulder having an outwardly facing top that is spaced from a web section of the respective frame section, said web section extending between and integrally connecting the two leg sections, and wherein said peripheral edge sections of said plate rest against and engage the respective internal shoulders of the frame sections.

19. A display device according to claim 18 wherein said LEDs are mounted in said frame sections in a space formed between said shoulders and between the web sections and the respective adjacent edge sections of the plate.

20. A display device according to claim 18 wherein said LEDs are mounted in said frame sections by means of one or more reflective adhesive strips.

21. A display device according to claim 15 wherein an inside surface of each leg section is formed with one or more elongate, flexible gripping projections that securely engage an adjacent surface of the plate.

22. A display device according to claim 15 wherein at least one of said frame sections includes an integral connecting flange that projects outwards and away from said plate, said connecting flange having holes for mounting the display device by means of fasteners.

23. A display device according to claim 13 wherein said plate is made of plastic material and said edge sections are partially melted in order to bond said LEDs to the edge sections.

24. A display device according to claim 13 wherein said reflective layer is a layer of fiberglass attached to said rear surface of the plate and adapted to cause light diffusion at said rear surface.

25. A light device capable of illumination by means of electrical power, said device comprising:
a cylindrical, tubular member consisting substantially of translucent or transparent material and having a first end, a second end, and cylindrical inner and outer surfaces extending between said first and second ends;
a plurality of spaced-apart, electrically connected, light emitting diodes (LEDs) mounted in a peripheral edge section of at least one of said first and second ends and connectable to a source of said electrical power, said LEDs being arranged to transmit light into said cylindrical member from said peripheral edge section during use of said light device;
a light reflective opaque layer covering said cylindrical inner surface arranged between said first and second ends, said opaque layer being arranged to reflect light through said cylindrical outer surface; and
an outer layer arranged on said cylindrical outer surface and allowing light to escape through at least a portion of said cylindrical outer surface, this outer layer being at least partially opaque or translucent.

26. A light device according to claim 25 wherein said LEDs are mounted on peripheral edge sections of each of said first and second ends and are arranged to transmit light into said cylindrical tubular member from both of said peripheral edge sections during use of the light device.

27. A light device according to claim 26 wherein said reflective opaque layer is provided by a cylindrical tube of reflective material arranged inside said tubular member and covering substantially all of said cylindrical inner surface.

28. A light device according to claim 27 wherein said opaque layer is made of fiberglass sheet material that diffuses the light striking the cylindrical inner surface.

29. A light device according to claim 26 wherein said tubular member is made of clear plastic and said LEDs are substantially evenly distributed about the circumference of each of said first and second ends and are mounted in a circumferential groove formed in each of said peripheral edge sections.

30. A light device according to claim 29 wherein said LEDs are held in place in each of said peripheral edge sections by means of reflective adhesive tape that extends substantially about the circumference of each of said peripheral edge sections.

31. A light device according to claim 26 wherein said outer layer is a plastic film having indicia formed thereon and a layer of pressure sensitive adhesive that is used to bond said plastic film to said cylindrical outer surface.

32. A light device capable of illumination by means of electrical power, said device comprising:
a plate made primarily of a transparent or translucent layer of material and having four side edges along its perimeter and substantially flat front and rear surfaces;
a plurality of spaced-apart, electrically connected, light emitting diodes (LEDs) mounted on a side edge section of two of said side edges and connectable to a source of electrical power, said two side edges extending at a substantial angle to each other and the LEDs mounted along one of the side edges being arranged to transmit light into said plate which crosses the path of light transmitted into said plate by the LEDs mounted along the other of the side edges;
means for reflecting light provided on said rear surface and on two of said side edges located opposite said two side edges along which said LEDs are mounted; and
a front layer extending over and attached to said front surface of said plate to provide a lighting effect, said front layer being at least partially opaque or translucent.

33. A light device according to claim 32 wherein said flat rear surface of said plate has been lightly sandblasted prior to said reflecting means being applied to said rear surface, the effect of said sandblasting being to cause diffusion of light reflected off said rear surface.

34. A light device according to claim 32 wherein said reflecting means includes at least one strip of reflecting tape adhesively bonded to each of said two opposite side edges.

35. A light device according to claim 32 wherein said front layer forms indicia and comprises at least one releasable plastic sheet bonded to said front surface of the plate.

36. A light device according to claim 32 wherein said reflecting means include a fiberglass sheet substantially covering said rear surface and attached thereto, said fiberglass sheet causing light diffusion at said rear surface.

37. A light device according to claim 32 wherein said reflecting means includes elongate plastic framing members each of which is detachably connected to a respective one of said side edges of said plate and each of said framing members has a U-shaped transverse cross-section and is made of light reflecting plastic material.

38. A light device according to claim 32 wherein said plate is about ⅜ inch thick and is formed with a groove extending lengthwise along the side edge sections, said LEDs being mounted in said groove.

39. A light device according to claim 32 wherein said plate material is plastic or plexiglass and each side edge section of said plate is partially melted so as to bond said LEDs to the respective side edge section.

40. A light device capable of being illuminated by means of electrical power, said light device comprising:
a transparent or translucent plate having a plurality of edge surfaces and substantially flat, front and rear surfaces;
elongate, opaque, light reflecting frame members mounted on said plate and extending along at least two of said edge surfaces;
a plurality of spaced-apart, electrically connected light emitting diodes (LEDs) mounted in a space between at least one of said frame members and an adjacent edge section of the plate and held in place by the at least one frame member, said LEDs being connectable to a source of said electrical power and being arranged to transmit light into said transparent or translucent plate during use of the light device; and
a light reflective layer on said rear surface of said plate;
a front layer capable of providing a desired lighting effect and extending over said front surface of said plate, said front layer being at least partially opaque or translucent,
wherein during use of said light device, light emitted by said LEDs is transmitted and reflected to said front layer in order to provide said lighting effect on said flat front surface.

41. A light device according to claim 40 wherein said front layer is a film sheet detachably mounted on said flat front surface, said film sheet forming indicia.

42. A light device according to claim 41 wherein said plate is substantially rectangular, has a maximum thickness of about ⅜ inch and has four of said edge surfaces, and said frame members extend along all four edge surfaces and are connected to one another at the corners of said plate.

43. A light device according to claim 40 wherein said substantially flat rear surface of said plate has been lightly sandblasted and then covered with said light reflective layer which comprises a light reflective sheet.

44. A light device according to claim 41 wherein said LEDs are attached by adhesive tape to an inner surface of the at least one frame member and said at least one frame member has a U-shaped transverse cross-section and two substantially parallel legs that extend respectively over edges portions of said front and rear surfaces of said plate.

45. A light device according to claim 44 wherein each of said legs is formed with an internal shoulder and the two shoulders of each frame member engage an adjacent one of the edge surfaces of said plate.

46. A light device according to claim 40 wherein said light reflective layer is a fiberglass sheet bonded to said rear surface of the plate, said fiberglass sheet causing light diffusion at said rear surface.

47. A light device operable by electrical power comprising:
a plate comprising a sheet of transparent or translucent material and having a peripheral edge and substantially flat front and rear surfaces;
a plurality of spaced-apart, electrically connected light emitting diodes (LEDs) mounted on a peripheral edge section of said sheet, extending along at least a substantial portion of said edge sections and connectable to a source of electrical power, said LEDs being arranged to transmit light into said plate during use of the light device;
means for diffusing light that strikes said rear surface;
a light reflecting, opaque strip affixed to said plate at said peripheral edge, extending along said peripheral edge, and capable of reflecting light back into said plate; and
a cover sheet detachably mounted on said front surface by means adhesive, said cover sheet being at least partially opaque or translucent and allowing light to pass through said front surface and produce a desired lighting effect.

48. A light device according to claim 47 wherein said diffusing means is a sheet of fiberglass capable of reflecting substantially all of the light striking said rear surface back into said plate, said sheet of fiberglass being attached to said rear surface.

49. A light device according to claim 47 wherein said diffusing means is provided by the rear surface of said plate being sufficiently rough to diffuse light striking said rear surface.
